(19) United States
(12) Patent Application Publication
(10) Pub. No.: US 2014/0263057 A1
(43) Pub. Date: Sep. 18, 2014

(54) PROCESS FOR RECOVERING OIL FROM AN OIL-BEARING FORMATION AND TREATING PRODUCED WATER CONTAINING ANTI-SCALING ADDITIVES

(71) Applicant: Veolia Water Solutions & Technologies North America, Inc., Moon Township, PA (US)

(72) Inventors: Stanton R. Smith, Belmont, MA (US); Jeremy Cardin, Belmont, MA (US); Benoit Tranape, Somerville, MA (US); Brad Biagini, Beaver, PA (US); Mark W. Hess, Zelienople, PA (US)

(73) Assignee: Veolia Water Solutions & Technologies North America, Inc., Moon Township, PA (US)

(21) Appl. No.: 14/205,654

(22) Filed: Mar. 12, 2014

Related U.S. Application Data
(60) Provisional application No. 61/784,649, filed on Mar. 14, 2013.

(51) Int. Cl. C02F 9/00; C02F 1/76; E21B 43/34; C02F 1/52; C02F 1/44

(52) U.S. Cl. CPC C02F 9/00; C02F 1/5245; C02F 1/44; C02F 1/444; E21B 43/34; C02F 1/76
USPC 210/638

(57) ABSTRACT

A method of recovering oil from an oil-bearing formation including recovering an oil-water mixture from the oil-bearing formation and separating produced water from the oil-water mixture. The produced water includes phosphonate anti-scalant compounds. An oxidant is mixed with the produced water to deactivate the phosphonate anti-scalant compounds, thereby permitting dissolved solids in the produced water to precipitate. After deactivating the phosphonate anti-scalant compounds, the produced water is directed into a ceramic membrane which filters the produced water, producing a permeate stream and a retentate stream having suspended solids and precipitants therein.

Applicant claims priority based on U.S. Provisional Patent Application No. 61/784,649 filed Mar. 14, 2013. The subject matter of this application in incorporated herein by reference.

### FIELD OF THE INVENTION

The present invention relates to oil recovery processes, and more particularly to oil recovery process that yield produced water containing anti-scaling additives.

### BACKGROUND OF THE INVENTION

Organic, phosphorous-based additives are commonly used in oilfield and gasfield produced water treatment as mineral scale and corrosion inhibitors. Especially, phosphonate compounds are used extensively as anti-precipitation inhibitors for sparingly soluble salts that can be readily precipitated from initially supersaturated produced waters. Ceramic membrane filtration is increasingly used as a means to remove suspended oil, grease, and inorganic solids such as scale formers from produced water to provide a product water that is suitable for reinjection and/or as feed water for ion exchange or reverse osmosis. However, presence of phosphonate anti-scalants in produced water at even moderate concentrations prevents precipitation of soluble salts and their subsequent removal by ceramic membranes.

### SUMMARY OF THE INVENTION

The present invention, in one embodiment, entails a process for recovering oil and treating resulting produced water having anti-scaling additives. The process includes recovering an oil-water mixture from the oil-bearing formation and separating the oil-water mixture to produce an oil product and the produced water. Deactivating the anti-scaling additives by mixing an oxidant and/or multivalent coagulant salt with the produced water thereby precipitates compounds previously kept in solution due to the presence of the anti-scaling additives. Additional chemical adjustment, such as pH adjustment, may be advisable to enable complete precipitation of the scale formers. After deactivating the anti-scaling additives, directing the produced water through a microfiltration or ultrafiltration membrane separation unit that removes free oil from the produced water and produces a permeate stream and a reject or retentate stream.

In another embodiment, the present invention entails a method of recovering oil from an oil-bearing formation and treating produced water having phosphonate anti-scalant compounds contained therein. The process includes recovering an oil-water mixture from the oil-bearing formation and separating oil from the oil-water mixture to produce an oil product and the produced water. Further, the process or method entails deactivating the phosphonate anti-scalant compounds by mixing an oxidant with the produced water, thereby precipitating compounds previously kept in solution due to the presence of the phosphonate anti-scalant compounds. After deactivating the phosphonate anti-scalant compounds, directing the produced water through a ceramic membrane and removing free oil and precipitated scale formers from the produced water and which produces a permeate stream and a reject stream.

Other objects and advantages of the present invention will become apparent and obvious from a study of the following description and the accompanying drawings which are merely illustrative of such invention.

### BRIEF DESCRIPTION OF THE DRAWINGS

FIG. 1 is a schematic illustration of an oil recovery process that treats produced water containing anti-scaling compounds or additives.

FIG. 2 is a schematic illustration of another embodiment of an oil recovery process and a method of treating resulting produced water containing anti-scaling additives or compounds.

### DESCRIPTION OF EXEMPLARY EMBODIMENTS

Scale-inhibiting chemicals are commonly added to produced waters from oil fields and gas fields. The function of these chemicals is to mitigate precipitation of minerals, especially sparingly soluble salts, present in the produced water that would occur during production and downstream processing of the water. Generally the compounds subject to producing scale are referenced as scale formers. Those compounds include but are not limited to: hardness, metals, alkalinity (including but not limited to carbonates), sulfates, silica, etc. . . . Such precipitation (scaling) leads to fouling and plugging of piping, valves, process equipment, and the oil-bearing formation. Scale inhibitors in common industrial use are uniformly organic, phosphorous-based additives and, most commonly, are phosphonate compounds.

Subsequent to primary separation of oil from anti-scalant-laden produced water, multiple processing options exist for further treatment of the produced water, including additional de-oiling, softening, suspended solids removal, etc. depending on the specific requirements at the producing location. A preferred downstream produced water treatment process is one in which the produced water from the primary oil/water separation step is treated by membrane microfiltration or ultrafiltration to further de-oil the water and remove substantially all suspended solids (TSS) from the water. Product water from membrane microfiltration or ultrafiltration is suitable for direct reinjection into oil-bearing formations, and/or suitable as a feed to ion exchange or reverse osmosis processes, and/or suitable for use in producing steam. A preferred membrane for such membrane microfiltration or ultrafiltration processes is an inorganic ceramic membrane structure. An optional desirable processing step for the produced water after the primary oil/water separation step and prior to the membrane microfiltration and ultrafiltration step involves treatment in a clarifier, in which specific chemical addition of coagulants and/or flocculants is performed, to precipitate and remove specific compounds from the water.

The presence of anti-scalant compounds in produced water has a several deleterious effects. First of all on the precipitation efficiency: by allowing scale formers to remain in solution the scale inhibitor allow more scale formers to pass through the membrane in the permeate stream as a soluble compound and reduce the efficiency of the precipitation process. Furthermore on the coagulation efficiency: by creating reducing conditions scale-inhibitors typically react with some of the coagulant used in the precipitation process or membrane process and limit their ability to coagulating particles. One example is Fe III which is converted into Fe II due to the presence of anti-scaling compounds, which lowers the coagulant efficiency. Finally on the productivity of microfiltration and ultrafiltration membrane processes: due to absorption on membrane surfaces of the scale inhibitors and their chemical interaction with other substances in the polarization layer on or within the microfiltration or ultrafiltration membrane, or for example to the conversion of Fe III into Fe II which can also induce some membrane fouling. These effects lead to poor scale formers removal and membrane fouling which is characterized as a reduction in process flux and/or permeability during the course of conducting the microfiltration or ultrafiltration membrane process.

To remedy such fouling problems in produced water treatment processes involving produced water containing anti-scalants subjected to downstream microfiltration or ultrafiltration, the present invention includes the use of an added process step in which an oxidant is introduced to the produced water subsequent to the primary oil/water separation step and prior to the membrane microfiltration or ultrafiltration step. This added step is also before an optional clarification process involving coagulation and flocculation. The added step provides for introduction of an oxidant and/or multivalent coagulant salt to the produced water in a tank and/or pipe (“reactor”) and providing sufficient residence time for the oxidant to deactivate the dissolved anti-scalant compounds with concomitant precipitation of minerals previously kept dissolved due to presence of active (non-deactivated) anti-scalant. A preferred form of oxidant is sodium hypochlorite. A preferred form of trivalent coagulant salt is the Ferric ion.

The process, as an alternate embodiment, could include the addition of chemicals to improve the precipitation beyond that obtained by simply deactivating the anti-scaling additives. In this regard, hydroxide ions in form of caustic, such as sodium hydroxide, or lime, such as Ca(OH)₂, can be added to increase the pH of the wastewater. The increase in pH, in some cases, can facilitate the precipitation of various contaminants in the wastewater such as hardness, metals, silica and alkalinity compounds.

Turning to FIGS. 1 and 2, shown therein is an oil recovery process including a treatment for resulting produced water having anti-scalant compounds therein. First, with respect to the FIG. 1 embodiment, water may be injected into an oil-bearing formation to facilitate the recovery of oil therein. In some oil recovery processes, the water injected into the oil-bearing formation includes anti-scalant compounds such as phosphonate compounds. These anti-scalant compounds can be introduced into the water during the injection process at the oil-bearing formations, at the water-oil production process at the production oil-bearing formations, or at surface collection facilities after production but before primary oil-water separation processes.

In a typical oil recovery process, an oil-water mixture is recovered from the oil-bearing formation. As indicated in FIG. 1, in some processes, an anti-scalant chemical is mixed with the oil-water mixture recovered from the oil-bearing formation. As indicated above, this can occur before a primary oil-water separation process is performed. Primary oil-water separation can be carried out by various conventional processes such as gravity or centrifugal separation. In other cases, the primary oil-water separation process may include discrete operations such as an emulsion heater treater, settling in skim tanks, and/or induced gas flotation. In any event, as shown in FIG. 1, the oil-water separation step yields oil and produced water. At this stage in the process, the produced water includes the anti-scaling additives discussed above.

Produced water from the primary oil-water separation process is directed to a mixed reactor (or directly injected into the pipe leading to the next step) where an oxidant is mixed with the produced water. The purpose of the oxidant is to deactivate the anti-scaling additives or compounds contained in the produced water. In the example shown in the FIG. 2 embodiment, the oxidant injected and mixed with the produced water is sodium hypochlorite. The amount of the oxidant is calibrated to the measured concentration of the anti-scaling compounds in the produced water. Alternatively, one can use Oxidation-Reduction Potential (ORP) as an “indicator” of the appropriate oxidant dosage. The residence time of the oxidant in the mixed reactor (stirred tank or pipe leading to the next step) is adjusted to provide suitable deactivation of the anti-scaling compounds, as evidenced by the observed precipitation of solids from compounds previously kept in solution by the action of the anti-scaling additives or compounds. Again, the primary function of the oxidant is to deactivate or nullify the effects of the anti-scalant compounds such that dissolved solids held in solution by the anti-scalant compounds will now precipitate from the produced water.

After the anti-scaling additives in the produced water have been deactivated in the mixed reactor, as an optional subprocess, the produced water can be directed to a clarification unit where suspended solids and precipitants can be removed from the produced water. The clarification unit can assume various configurations. In one embodiment, the clarification unit includes one or more mixing tanks followed by a settling tank which would typically include lamella. An example of such a clarification unit is a system sold by Veolia Water Solutions and Technologies North America under the trademark MULTIFLO. Furthermore, various chemicals can be injected and mixed with the produced water in the clarification unit to promote the settling and recovery of suspended solids and precipitants. For example, various ferric salts can be added as coagulants and, in addition, polymer flocculants can be added. These chemicals facilitate precipitation and settling of suspended solids and precipitants. In addition, other chemicals such as caustic soda, lime, soda ash, magnesium oxide, magnesium chloride can be added to facilitate the removal of hardness, metals, alkalinity and silica from the produced water. The suspended solids and precipitants that settle in the settling tank of the clarifier unit forms sludge and the sludge can be removed and disposed of or subjected to further treatment.

The clarified effluent from the clarification unit is directed to a microfiltration or ultrafiltration membrane separation unit to be further polished. This membrane separation unit produces a reject or retentate that includes suspended solids, precipitants, free oil and emulsified oil. In the embodiment illustrated herein, the reject or retentate from the membrane separation unit is recycled to the clarification unit for further treatment. The reject or retentate recycled to the clarification unit can assist in the efficient precipitation and settling of suspended solids and precipitants and can facilitate the crystallization of these suspended solids and precipitants. The permeate from the membrane separation unit is fully de-oiled and devoid of significant suspended solids and precipitants and, hence, is suitable for direct rejection into oil-bearing formations, or suitable as a feed to ion exchange or reverse osmosis units, or suitable for producing steam.

The process shown in FIG. 2 is similar to that shown in FIG. 1 and discussed above. The basic difference is that in the process of FIG. 2, it is recognized that one of the most common anti-scaling additives is a phosphonate-based chemical. Thus, the process shown in FIG. 2 is designed to deactivate or nullify the effects of the phosphonate-based anti-scalant. To achieve this, in one exemplary embodiment, the oxidant selected is sodium hypochlorite. As seen in FIG. 2, after primary oil-water separation, the sodium hypochlorite oxidant is mixed with the produced water and functions to effectively deactivate the phosphonate-based anti-scalant contained in the produced water.

Details of the ceramic membrane are not dealt with herein because such is not per se material to the present invention, and further, ceramic membranes are known in the art. For a review of general ceramic membrane technology, one is referred to the disclosures found in U.S. Pat. Nos. 6,165,553 and 5,611,931, the contents of which are expressly incorporated herein by reference. These ceramic membranes, useful in the processes disclosed herein, can be of various types. In some cases the ceramic membrane may be of the type that produces both a permeate stream and a reject stream. On the other hand, the ceramic membranes may be of the dead head type, which only produces a permeate stream and from time-to-time the retentate is backflushed or otherwise removed from the membrane.

The structure and materials of ceramic membranes as well as the flow characteristics of ceramic membranes vary. When ceramic membranes are used to purify produced water, the ceramic membranes are designed to withstand relatively high temperatures as it is not uncommon for the produced water being filtered by the ceramic membranes to have a temperature of approximately 90° C. or higher.

Ceramic membranes normally have an asymmetrical structure composed of at least two, mostly three, different porosity levels. Indeed, before applying the active, microporous top layer, an intermediate layer is formed with a pore size between that of the support and a microfiltration separation layer. The macroporous support ensures the mechanical resistance of the filter.

Ceramic membranes are often formed into an asymmetric, multi-channel element. These elements are grouped together in housings, and these membrane modules can withstand high temperatures, extreme acidity or alkalinity and high operating pressures, making them suitable for many applications where polymeric and other inorganic membranes cannot be used. Several membrane pore sizes are available to suit specific filtration needs covering microfiltration and ultrafiltration ranges.

Ceramic membranes today run the gamut of materials (from alpha alumina to zircon). The most common membranes are made of Al, Si, Ti or Zr oxides, with Ti and Zr oxides being more stable than Al or Si oxides. In some less frequent cases, Sn or Hf are used as base elements. Each oxide has a different surface charge in solution. Other membranes can be composed of mixed oxides of two of the previous elements, or are established by some additional compounds present in minor concentration. Low fouling polymeric coatings for ceramic membranes are also available.

Ceramic membranes are typically operated in the cross flow filtration mode. This mode has the benefit of maintaining a high filtration rate for membrane filters compared with the direct flow filtration mode of conventional filters. Cross flow filtration is a continuous process in which the feed stream flows parallel (tangential) to the membrane filtration surface and generates two outgoing streams.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of recovering oil from an oil-bearing formation and treating produced water containing an anti-scalant compound, comprising:
recovering an oil-water mixture from the oil-bearing formation;
separating oil from the oil-water mixture to produce an oil product and the produced water;
deactivating the anti-scalant compound by mixing an oxidant and multivalent coagulant salt with the produced water, thereby precipitating compounds previously kept in solution due to the presence of the anti-scalant compounds; and
after deactivating the anti-scalant compound, directing the produced water through a ceramic membrane to remove oil from the produced water and producing a permeate stream and a retentate stream.

2. The method of claim 1 wherein after deactivating the anti-scalant compound and prior to filtering the produced water in the ceramic membrane, directing the produced water to a solids separator and separating suspended solids and precipitants from the produced water.

3. The method of claim 2 including adding one or more reagents to the produced water in the solids separator to facilitate the precipitation and settling of solids.

4. The method of claim 1 wherein the oxidant is sodium hypochlorite.

5. The method of claim 1 wherein the produced water includes a phosphonate anti-scalant compound.

6. The method of claim 5 including deactivating the phosphonate anti-scalant compound by mixing sodium hypochlorite and a ferric salt with the produced water.

7. A method of recovering oil from an oil-bearing formation and treating produced water containing anti-scaling additives, comprising:
recovering an oil-water mixture from the oil-bearing formation;
separating oil from the oil-water mixture to produce an oil product and the produced water;
deactivating the anti-scaling additives by mixing an oxidant and multivalent coagulant salt with the produced water, thereby precipitating compounds previously kept in solution due to the presence of the anti-scaling additives;
de-oiling the produced water; and
after deactivating the anti-scaling additives, directing the produced water through a microfiltration or ultrafiltration membrane separation unit and producing a permeate stream and a reject stream having suspended solids and precipitants therein.

8. The method of claim 7 wherein after deactivating the anti-scalant compound and prior to filtering the produced water in the membrane separation unit, directing the produced water to a solids separator and separating suspended solids and precipitated scale formers from the produced water.

9. The method of claim 8 including adding one or more reagents to the produced water in the solids separator to facilitate the precipitation and settling of solids.

10. The method of claim 7 wherein the oxidant is sodium hypochlorite.

11. The method of claim 7 wherein the produced water includes a phosphonate anti-scalant compound.

12. The method of claim 11 including deactivating the phosphonate anti-scalant compound by mixing sodium hypochlorite or a ferric salt with the produced water.
